(19) United States
(12) Patent Application Publication
(10) Pub. No.: US 2026/0344561 A1
(43) Pub. Date: Nov. 5, 2026

(54) Electro-Mechanical Flexible Cutterbar Flotation System

(71) Applicant: CNH Industrial America LLC, New Holland, PA (US)

(72) Inventors: Joel Cook, Akron, PA (US); Cory Hunt, Millersville, PA (US)

(73) Assignee: CNH Industrial America LLC, New Holland, PA (US)

(21) Appl. No.: 19/198,192

(22) Filed: May 5, 2025

(51) Int. Cl. A01D 34/00; A01D 34/04; A01D 34/24

(52) U.S. Cl. CPC A01D 34/006; A01D 34/04; A01D 34/243

(57) ABSTRACT

A header includes a frame, rotatable arms mounted to the frame, and a cutterbar supported by the rotatable arms. An electro-mechanical actuator includes (i) a motor having an extendable output shaft that is configured to rotate one of the rotatable arms and thereby adjust a position of the cutterbar, and (ii) a sensor that is configured to sense a position of the output shaft. A method for using the header includes receiving the sensed position from the sensor; determining a force to be exerted by the output shaft as a function of the sensed position based upon a look-up table, an equation or an algorithm; and causing the motor, by the controller, to exert the determined force thereby resulting in a changed ground reaction force at the cutterbar.

### FIELD OF THE INVENTION

The present invention relates generally to crop harvesting headers for use with crop harvesting devices. It relates more particularly to an electro mechanical system for supporting a floating cutterbar of a crop harvesting header.

### BACKGROUND OF THE INVENTION

As is described in U.S. Pat. No. 12,150,409, which is incorporated by reference herein in its entirety, the disclosure relates generally to a harvester header. A combine (e.g., combine harvester) is a type of harvester generally used to harvest certain crops that include grain (e.g., barley, corn, flax, oats, rye, wheat, etc.). During operation of a combine, the harvesting process may begin by removing a plant from a field, such as by using a header. The header may cut the agricultural crops and may transport the cut crops to a processing system of the combine.

Generally, the harvester may be driven through a field to harvest crops. A cutter bar assembly of the header may engage the soil surface to cut the agricultural crops proximate to the soil surface. As the harvester moves through the field, the cutter bar assembly may flex to adjust to the contour of the field. A conventional cutter bar assembly of the header may be urged upwardly by a hydraulic system to control a contact force between the cutter bar assembly and the ground (e.g., the soil surface).

With recent advances in electric actuator technology, the aforementioned hydraulic system may be replaced by one or more electric actuators. As will be described later, electromechanical actuators have some important features including internal position monitoring, internal force monitoring, high speed motion, integrated brake with power off, programable force profile based off position, programable up/down stop in positions, and embedded control systems that can communicate via CAN or other systems to a central control system. Such features can be important in a header design, as will be described hereinafter.

### SUMMARY OF THE INVENTION

A header includes a frame, rotatable arms mounted to the frame, and a cutterbar supported by the rotatable arms. An electro-mechanical actuator includes (i) a motor having an extendable output shaft that is configured to rotate one of the rotatable arms and thereby adjust a position of the cutterbar, and (ii) a sensor that is configured to sense a position of the output shaft. A method for using the header includes receiving, at the controller, the sensed position from the sensor; determining, by the controller, a force to be exerted by the output shaft as a function of the sensed position based upon a look-up table, an equation or an algorithm; and causing the motor, by the controller, to exert the determined force thereby resulting in a changed ground reaction force at the cutterbar

### BRIEF DESCRIPTION OF THE DRAWINGS

The drawing figures depict one or more implementations, by way of example only, not by way of limitations. In the figures, like reference numerals refer to the same or similar elements.

FIGS. 1 and 2 are side and front views, respectively, of an embodiment of a crop harvesting device and harvesting header of the present invention.

FIG. 3 is a top perspective view of the header of FIG. 1 of the present invention.

FIG. 4 is a cross section taken along line 4-4 in FIG. 3.

### DETAILED DESCRIPTION OF THE INVENTION

The terms “forward,” “rearward,” “left,” and “right,” when used in connection with the agricultural harvester (e.g., combine) and/or components thereof are usually determined with reference to the direction of forward operative travel of the combine, but they should not be construed as limiting. The terms “longitudinal” and “transverse” are determined with reference to the fore-and-aft direction of the agricultural combine and are equally not to be construed as limiting.

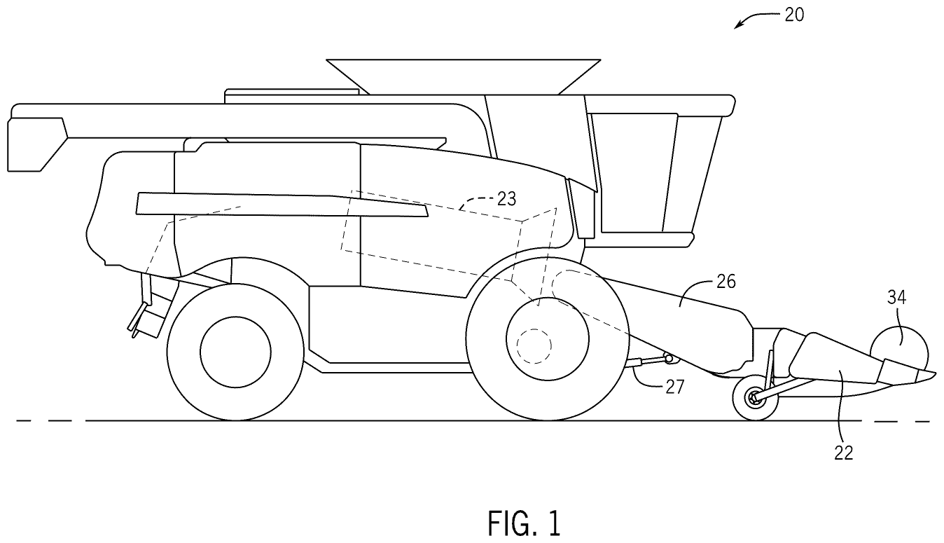

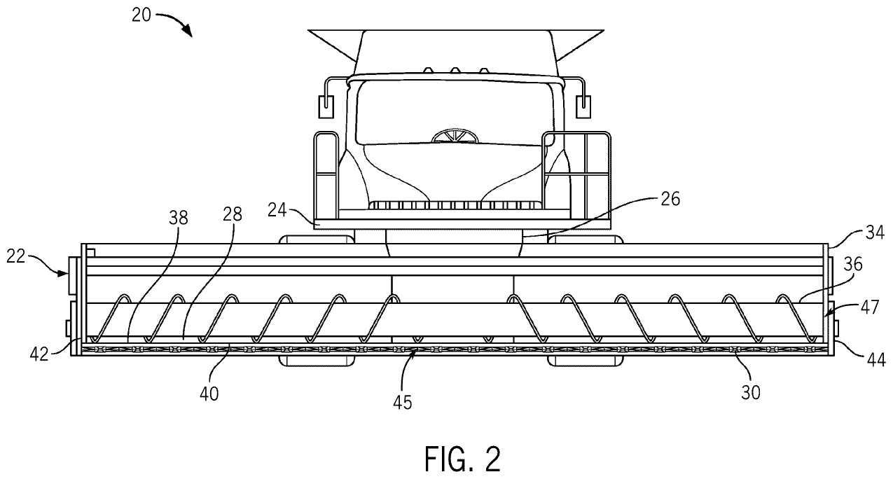

FIGS. 1 and 2 depict a combine 20, which is a well-known agricultural cutting and harvesting machine having (i) a header 22, which is configured to cut or sever crops and to induct the cut or severed crops into a feeder 26, (ii) a threshing unit 23 for threshing the inducted crops, and (iii) further conventional features which are known in the art and not described herein. The basic features of combine 20 are described in U.S. Pat. No. 8,601,779, which is incorporated by reference herein in its entirety.

Header 22 is attached to feeder 26 at a forward end 24 of combine 20. Feeder 26 and header 22 attached thereto are raised by an actuator 27. Header 22 includes a frame 47 to which the other header components are attached. Header 22 may include an elongate, sidewardly extending reel 34. Reel 34 is rotatable in a direction suitable for facilitating the induction of cut or severed crops into feeder 26. Header 22 further includes an elongate, rotatable auger 36, which extends in close proximity to a top surface 38 of a header floor 28 and has helical flights therearound. Auger 36 is configured to cooperate with reel 34 in conveying cut or severed crops to feeder 26, which is configured to convey the cut or severed crops into combine 20 for threshing and cleaning.

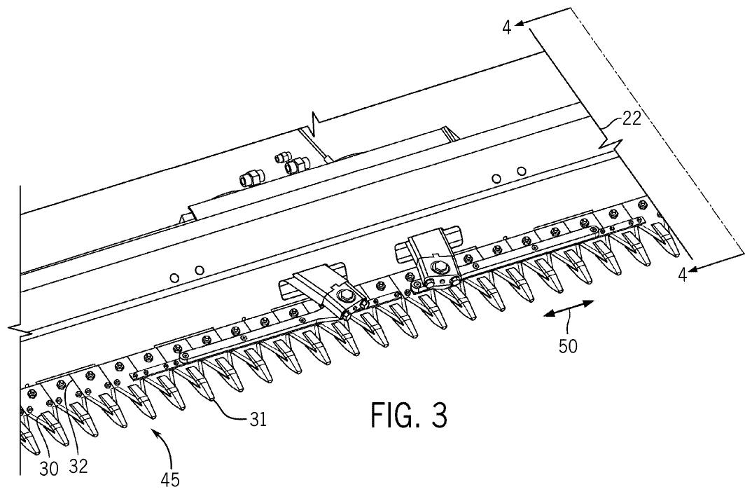

Turning to FIGS. 2-4, header 22 includes an elongated sidewardly extending cutterbar assembly 45 along a forward edge portion of floor 28. A plurality of independently rotatable arms 48 are attached to frame 47 and cooperatively support cutterbar assembly 48. The purpose and operation of arms 48 will be described later.

Cutterbar assembly 45 broadly includes a flexible cutterbar, skid plates (not shown), and a sickle assembly 30. The cutterbar comprises a substantially continuous and flexible bar that extends lengthwise along substantially the entire width of the header 22 and thereby extends in a lateral direction relative to the normal direction of travel of the header 22. The skid plates are secured to a lower side of the cutterbar and are spaced along the length of the cutterbar.

Sickle assembly 30 of cutterbar assembly 45 extends along a forward edge 40 of floor 28, and generally is bounded by a first side edge 42 and an opposing second side edge 44 of floor 28. The sickle assembly 30 includes (i) reciprocating knives 32 that are slidably mounted on the cutterbar for severing the crop and (ii) static knife guards 31 that are fixedly mounted to the cutterbar and/or arms 48. Sickle assembly 30 is configured to cut or sever crops in preparation for induction into feeder 26 of combine 20. During operation, knives 32 reciprocate rapidly to effect a cutting or severing action that cuts or severs plant stems, stalks or other material present between the knife blades of the sickle. As denoted by arrow 50, the sickle blades can reciprocate sideways. Further details of a cutterbar assembly are provided in U.S. Pat. No. 8,225,590, which is incorporated by reference herein in its entirety.

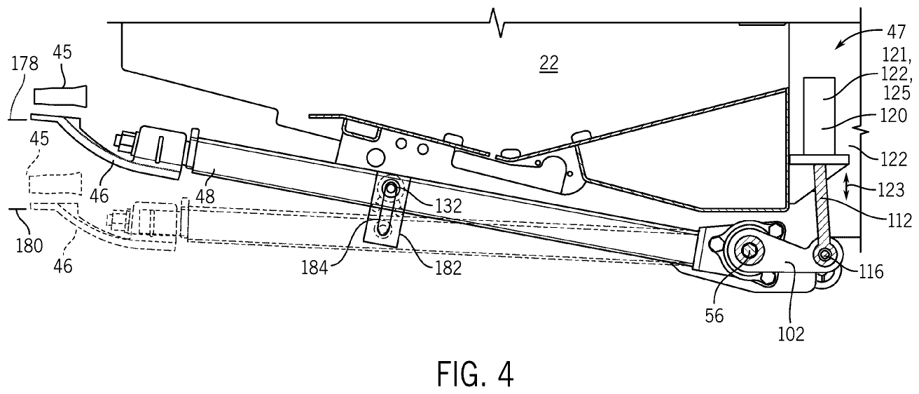

FIG. 4 shows cutterbar 45 being supported by arms 48 (one arm shown). Specifically, cutterbar 45 is supported on first end 46 of arm 48. First end 46 may optionally form part of one of the knife guards described above. As noted above, each arm 48 is independently rotatable with respect to header frame 47. Each arm 48 is pivotably mounted to frame 47 (or a component mounted to frame 47) about a hinge point/axis 56 that is located at the second end of arm 48. A link 102 is rotatably fixed to the second end of arm 48 such that link 102 rotates along with arm 48 about axis 56.

In FIG. 4, cutterbar 45 and arm 48 are shown in a raised position 178 (solid lines) as well as a lowered position 180 (dashed lines). Raised position 178 corresponds to stop 132 being positioned at an upper extent of a slot 184 formed in bracket 182 of frame 47. Lowered position 180 corresponds to stop 132 being positioned at a lower extent of slot 184 formed in bracket 182 of frame 47. The different positions may be used for different kinds of crops, for example.

An actuator 120 engages the link 102 to cause pivoting of arm 48 about axis 56 between the two positions 178 and 180 shown in FIG. 4. One actuator 120 may be associated with arm 48 whereas different actuators 120 may be associated with the other arms 48. Actuator 120 includes a housing that may be fixedly mounted to frame 47. An electric motor and screw-type arrangement is disposed in the housing for causing translation of an output shaft 112 of actuator 120 in the direction of arrows 123. Output shaft 112 is connected to link 120 by a bearing 116. Actuator 120 may be an electric screw-type linear actuator, such as those distributed by EWELLIX® and described in U.S. Patent App. Pub. No. 20200400517 ('517 Publication), which is incorporated by reference herein in its entirety. Actuator 120 may have an integrated load sensor 122 (as described in the '517 Publication) as well as a position sensor 125 that detects the degree of axial extension of the output shaft 112 of the actuator. The position sensor 125 may be, for example, a potentiometer, an optical sensor, an IR sensor or a Hall effect sensor. Each actuator 120 may be independently controlled by its own computer controller 121, or all of the actuators 120 may be collectively controlled by a common computer controller. Load sensor 122 may be omitted, if so desired. Further details of actuator 120 are described in the '517 Publication.

Actuators 120 together provide a flotation system for cutterbar assembly 45. In contrast, a conventional floatation system typically comprises a hydraulic system with a group of hydraulic cylinders sharing a common group of accumulators. The accumulators provide a generally flat pressure to the cylinders regardless of stroke position so that the accumulators provide even flotation pressure on the ground. One challenge is that the various sections of the header have different weights. The center infeed area may be heavier than the other sections, for example, leading to bowing of the header. To address this problem, the conventional hydraulic system may include different cylinders or mechanical levers which accommodate the uneven weighting to deliver a uniform flotation pressure across the length of the header. Time-consuming experimentation is typically required in order to achieve a sufficient uniform flotation pressure across the length of the header.

As noted above, with recent advances in electric actuator technology, conventional hydraulic lifting systems (and other systems) may be replaced by electronically controlled actuators (i.e., actuators 120). Using the position sensor 125, each actuator 120 can monitor the position (e.g., axial extension value) of the output shaft 112 as the cutterbar travels along an uneven ground surface. Based upon the position of the output shaft 112, the controller 121 will adjust the output force of the actuator 120, as appropriate, so as to maintain a pre-determined ground reaction force between the cutterbar and the ground. The output force of the actuator 120 may be continuously monitored by the load sensor 122. By controlling the output force of the actuator 120, the reaction force between the cutterbar and the ground can be altered over the full range of vertical motion of the cutterbar.

The controller 121 can instruct the actuator 120 to maintain a specific output force (e.g., by either extending or retracting the output shaft 112) as a function of an equation, algorithm or lookup table that is stored in the memory of the controller 121. The look-up table includes extension values for the output shaft 112 (input data) vs. the output force exerted by the actuator 120 (output data), such that there is an output force value for every shaft extension value sensed by the sensor 125. The relationship (i.e., force profile) between output shaft extension and force values may be linear or non-linear, for example. The relationship may be tailored such that the cutterbar behaves like a spring or exerts a constant force against the ground, and so forth. It is further noted that the look-up table for one actuator 120 may differ from the look-up table for a different actuator 120 such that each actuator 120 is independently tuned based on its function, purpose and/or position on the header.

For example, an actuator 120 can be programed for one force profile when it is positioned at the infeed of the header 22, a different force profile when it is positioned at the flex arms 48, and a third force profile when it is positioned at a divider of the header 22 (i.e., the different sections of the header having different weights). The force profile can then be modified or optimized via software to make the systems match. In addition, it could be possible to have a different force profile in a single actuator 120 depending on the positions of the actuators 120 that are located beside the single actuator 120.

Actuators 120 can be employed for setting the two “stop” positions shown in FIG. 4. In contrast, conventional hydraulic flotation system requires a mechanical system to set the up/down stop positions. Due to manufacturing tolerances, conventional headers can include a mechanical system adjustment enabling an end user (or factory) to straighten the cutterbar in the fully up or fully down position. When the conventional header is set to a flex mode, the full range of flexibility is used; and, when the header is set to a rigid mode, the hydraulic system is maximized to push the arms against their upper stops.

Using position control by the actuators 120, the actuators 120 can be programed to have a down-stop that causes the cutterbar assembly 45 to be perfectly straight as well as an up-stop that causes the cutterbar assembly 45 to be perfectly straight. An end user operator could decide in a certain condition, for example, to use a certain percentage of the flexible range (e.g., the top 25%) and this could be selected from the cab of the combine. This selection could be useful when cutting at a high elevation off of the ground in rigid mode while also desiring to follow the ground but not get too far from the reel. In contrast, hydraulic systems can be slow (e.g., 10-15 seconds) to shift from flex mode to rigid mode due to the accumulators, however, the electric actuators 120 would have a faster response time because they do not require accumulators. Each actuator 120 could be driven to a known position, or their default brake could be engaged to lock the cutterbar in its current position.

According to one exemplary calibration mode for actuator 120, the cutterbar may be lowered onto a level ground surface so that cutterbar would be in a straightened configuration. The output shaft extension value and the sensed force in the actuator 120 may then be recorded (by the operator selecting an icon on a control panel) and saved as values in the look-up value. The recorded values would correspond to the straightened configuration of the cutterbar. In this way the straightened configuration of the cutterbar may be reproduced by the operator on an on-demand basis, as desired. This mode addresses the bowing challenges described above.

It is noted that the details of actuator 120 may also be relevant to actuator 27 for controlling the height of header 22 in an auto header height control (AHHC) system. Each actuator 27 would be able to report its position to a controller thereby providing enhanced feedback for the AHHC system.

It is to be understood that the operational steps described herein are performed by the controller 121 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 121 described herein is implemented in software code or instructions which are tangibly stored on a tangible computer readable medium. Upon loading and executing such software code or instructions by the controller 121, the controller 121 may perform any of the functionality of the controller 121 described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A header for an agricultural vehicle, said header comprising:
a frame;
a plurality of rotatable arms that are each independently and rotatably mounted to the frame;
a cutterbar supported by the rotatable arms, the cutterbar being configured for removing crop from a ground surface;
an electro-mechanical actuator comprising (i) a motor having an extendable and retractable output shaft that is configured to rotate one of the rotatable arms and thereby adjust a position of the cutterbar relative to the ground surface, and (ii) a sensor that is configured to sense a position of the output shaft; and
a controller that is configured to (i) receive the position of the output shaft from the sensor, (ii) determine a force to be exerted by the output shaft as a function of the sensed position based upon a look-up table, an equation or an algorithm, and (iii) cause the motor to exert the determined force thereby resulting in a changed ground reaction force at the cutterbar.

2. The header of claim 1, wherein the electro-mechanical actuator is a screw-type linear actuator.

3. The header of claim 1, further comprising a plurality of electro-mechanical actuators, each electro-mechanical actuator being associated with one of the rotatable arms of the plurality of rotatable arms.

4. The header of claim 3, wherein each actuator comprises its own controller.

5. The header of claim 4, wherein each controller has its own look-up table, equation or algorithm.

6. The header of claim 5, wherein the look-up tables, equations or algorithms differ between the controllers.

7. The header of claim 5, wherein the look-up tables, equations or algorithms differ based on a position of the actuators on the header.

8. The header of claim 1, wherein the electro-mechanical actuator does not form part of a hydraulic system.

9. The header of claim 1, wherein the sensor is internal to the electro-mechanical actuator.

10. An agricultural harvester comprising the header of claim 1.

11. A method of using a header for an agricultural vehicle, the header including a frame; a plurality of rotatable arms that are each independently and rotatably mounted to the frame; a cutterbar supported by the rotatable arms, the cutterbar being configured for removing crop from a ground surface; an electro-mechanical actuator comprising (i) a motor having an extendable and retractable output shaft that is configured to rotate one of the rotatable arms and thereby adjust a position of the cutterbar relative to the ground surface, and (ii) a sensor that is configured to sense a position of the output shaft; and a controller that is operatively connected to the sensor and the motor, said method comprising:
receiving, at the controller, the position of the output shaft from the sensor,
determine, at the controller, a force to be exerted by the output shaft of the motor as a function of the sensed position based upon a look-up table, an equation or an algorithm, and
causing the motor, by the controller, to exert the determined force thereby resulting in a changed ground reaction force at the cutterbar.

12. The method of claim 11, wherein the header further comprises a plurality of electro-mechanical actuators, each electro-mechanical actuator being associated with one of the rotatable arms of the plurality of rotatable arms, wherein each actuator comprises its own controller.

13. The method of claim 12, wherein each controller has its own look-up table, equation or algorithm such that each actuator is operated according to its own look-up table, equation or algorithm.

14. The method of claim 13, wherein the look-up tables, equations or algorithms differ based on a position of the actuators on the header.

15. The method of claim 11, wherein the controller is configured to calibrate the look-up table when set to a calibration mode and upon lowering the cutterbar onto the ground surface.
